(19) United States
(12) Patent Application Publication
(10) Pub. No.: US 2014/0132841 A1
(43) Pub. Date: May 15, 2014

(54) SYSTEMS AND METHODS FOR DIGITALLY ORGANIZING THE PHYSICAL PRODUCTION FOR MEDIA PRODUCTIONS

(71) Applicant: WYMSEE, Cambridge, MA (US)

(72) Inventors: Brett BEAULIEU-JONES, Cambridge, MA (US); Alex LOVERDE, Cambridge, MA (US); Jeff IMPEY, Cambridge, MA (US); Dan STEFANIS, Cambridge, MA (US)

(73) Assignee: WYMSEE, Cambridge, MA (US)

(21) Appl. No.: 14/078,706

(22) Filed: Nov. 13, 2013

Related U.S. Application Data
(60) Provisional application No. 61/725,629, filed on Nov. 13, 2012.

(51) Int. Cl. H04N 5/60

(52) U.S. Cl. CPC H04N 5/602
USPC 348/722

(57) ABSTRACT

The disclosed apparatus, systems, and methods are for digitally organizing the physical production for media productions. An electronic script for a media production is received that includes a plurality of scenes with at least one or more characters and one or more sets. The electronic script is processed to automatically generate a script data object that comprises data indicative of the plurality of scenes, data indicative of the at least one or more characters for the scene, data indicative of the one or more sets for the scene, and data indicative of at least one or more items for a character from the one or more characters, a set from the one or more sets, or both. The script data object is electronically distributed to one or more departments involved in producing the media production to electronically organize the physical production of the media production.

### RELATED APPLICATIONS

The present application relates to and claims priority under 35 U.S.C. 119(e) to U.S. Provisional Application No. 61/725,629, filed on Nov. 13, 2012 and entitled “Systems and Methods for Digitally Sourcing, Organizing and Tracking Inventory Used in Media Production,” the disclosure of which is hereby incorporated by reference herein in its entirety.

### TECHNICAL FIELD

The disclosure relates to a system and method for digitally organizing the physical production process for media productions (e.g., Television, Film, Digital Internet Shorts and live performance). The disclosure also relates to a system and method for delivery of this information to power analytics and consumer experiences. The disclosure also relates to a system and method for the budgeting, sourcing (both sponsored and acquired), and tracking of inventory used in media productions.

### BACKGROUND

In recent years two themes have emerged surrounding television and film productions. First, production of content has become increasingly digitized. Second, content is becoming increasingly interactive through social media, interactive video players, second screen devices etc. The idea of “shoppable-television” is becoming increasingly popular, but in the current ecosystem is not possible.

There have been numerous approaches to create shoppable-television, but each previous approach fails to source accurate actual product information. To secure accurate granular data, it is preferable for software to fit directly into the workflow of the creative professionals designing the looks for these productions.

### SUMMARY

In accordance with the disclosed subject matter, apparatus, systems, non-transitory computer-readable media, and methods are provided for a physical production management system for creative productions (television, film and live production) and, more specifically, a software system for tracking the inventory used in production creating a rich and extensible database.

The disclosed subject matter includes a computerized method for electronically organizing physical production of a media production. A computing device receives an electronic script for a media production, the script comprising a plurality of scenes, each scene comprising at least one or more characters for the scene and one or more sets for the scene. The computing device processes the electronic script to automatically generate a script data object that comprises data indicative of the plurality of scenes, and for each scene: data indicative of the at least one or more characters for the scene, data indicative of the one or more sets for the scene, and data indicative of at least one or more items for a character from the one or more characters, a set from the one or more sets, or both. The computing device electronically distributes the script data object to one or more departments involved in producing the media production to electronically organize the physical production of the media production among the one or more departments.

The disclosed subject matter includes a computerized system for electronically organizing physical production of a media production. The computerized system includes a processor configured to run a module stored in memory that is configured to cause the processor to receive an electronic script for a media production, the script comprising a plurality of scenes, each scene comprising at least one or more characters for the scene and one or more sets for the scene. The module stored in memory is configured to cause the processor to process the electronic script to automatically generate a script data object that comprises data indicative of the plurality of scenes, and for each scene: data indicative of the at least one or more characters for the scene, data indicative of the one or more sets for the scene, and data indicative of at least one or more items for a character from the one or more characters, a set from the one or more sets, or both. The module stored in memory is configured to cause the processor to electronically distribute the script data object to one or more departments involved in producing the media production to electronically organize the physical production of the media production among the one or more departments.

The disclosed subject matter includes a non-transitory computer readable medium. The non-transitory computer readable medium has executable instructions operable to cause an apparatus to receive an electronic script for a media production, the script comprising a plurality of scenes, each scene comprising at least one or more characters for the scene and one or more sets for the scene. The non-transitory computer readable medium has executable instructions operable to cause an apparatus to process the electronic script to automatically generate a script data object that comprises data indicative of the plurality of scenes, and for each scene: data indicative of the at least one or more characters for the scene, data indicative of the one or more sets for the scene, and data indicative of at least one or more items for a character from the one or more characters, a set from the one or more sets, or both. The non-transitory computer readable medium has executable instructions operable to cause an apparatus to electronically distribute the script data object to one or more departments involved in producing the media production to electronically organize the physical production of the media production among the one or more departments.

Production designers including the costume department; the hair and make-up department; the art department (set designers and prop masters); the sound and camera department; and the script department can use the system to track all of the products and materials used in production.

The system's database can be used to create new revenue opportunities for productions through consumer discovery experiences, marketing analytics and enhanced advertising integration for brands/advertising agencies, and increased product placement.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 depicts the process in which production staff use inventory management software, according to embodiments of the present disclosure.

FIG. 2 illustrates the workflow of the Costume Department while using production management system, according to embodiments of the present disclosure.

FIG. 3 differentiates between the different roles within the costume department as well as their workflow while using the production management system, according to embodiments of the present disclosure.

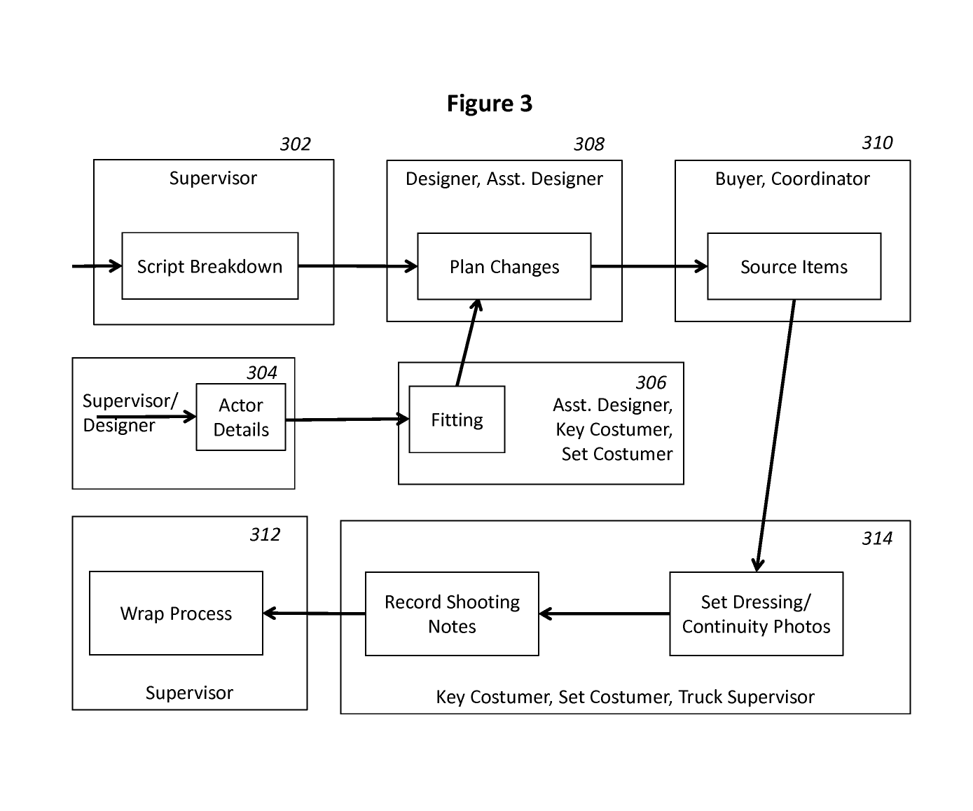

FIG. 4 illustrates the workflow of the Hair and Make-up Departments while using the production management system, according to embodiments of the present disclosure.

FIG. 5 illustrates the workflow of the Props Department while using the production management system, according to embodiments of the present disclosure.

FIG. 6 illustrates the workflow of the Art Department (specifically Set Decorators) while using the production management system, according to embodiments of the present disclosure.

FIG. 7 illustrates the workflow of the Locations Department while using the production management system, according to embodiments of the present disclosure.

FIG. 8 illustrates the workflow of the Camera and Electric (Lighting) Departments while using the production management system, according to embodiments of the present disclosure.

FIG. 9 illustrates the workflow of the Construction Department while using the production management system, according to embodiments of the present disclosure.

FIG. 10 illustrates the workflow of the Production Office (specifically Script Supervisor and Assistant Directors) while using the production management system to plan a production, according to embodiments of the present disclosure.

FIG. 11 illustrates the workflow Production leadership (Producers and Directors) can use to supervise their production, including approving/providing feedback on creative plans and budgets, auditing expenses and reviewing reports.

FIG. 12 details an API that can be used to power consumer experiences as well as brand analytics, according to embodiments of the present disclosure.

FIG. 13 depicts a sample data return for the API call of what is on screen, according to embodiments of the present disclosure.

FIG. 14 provides an example of the flow from a Product Placement agent to the production, as well as the flow of data and analytics around the placement back to the Product Placement agent, according to embodiments of the present disclosure.

FIG. 15 displays the path of analytics on product placement, according to embodiments of the present disclosure.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

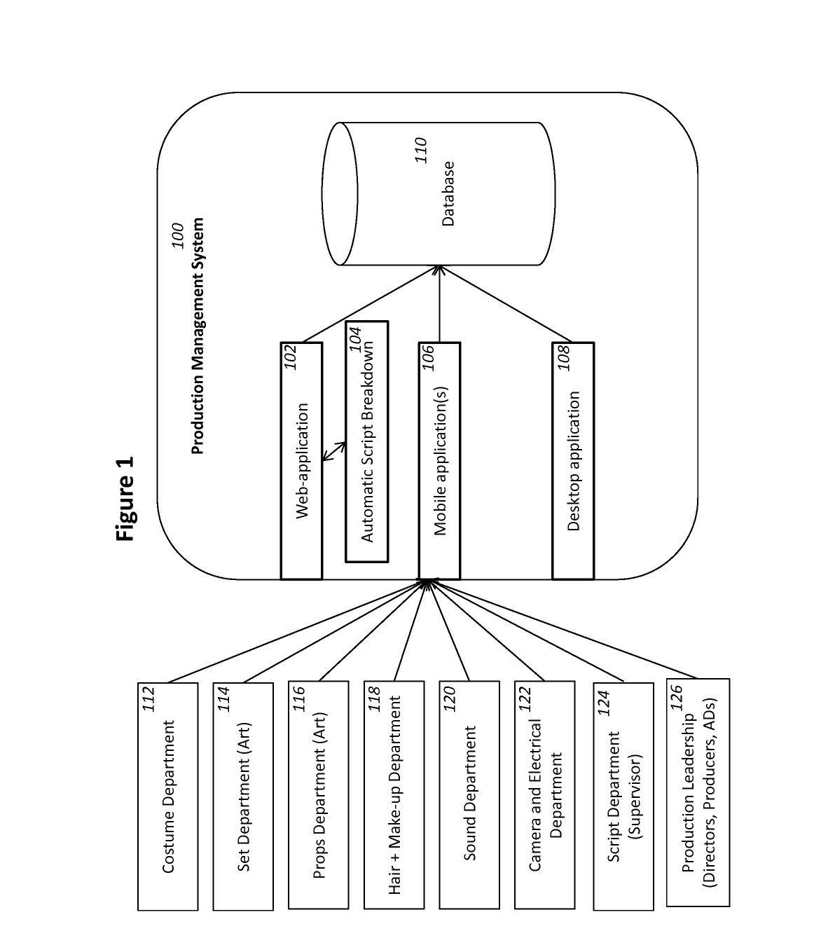

FIG. 1 depicts the process in which production staffs use a production management system 100, which executes the production management software described herein. However, one skilled in the art can appreciate that it can include different components or elements with departing from the spirit of the techniques described herein. This software can be a cloud application accessible via the web 102, mobile devices 106 as well as a desktop application 108.

Users of production management system 100 include a Costume Department 112 who is responsible for all the clothing and apparel worn by all of the actors that appear on screen, an Art Department 114, responsible for the overall look, atmosphere and emotion that move the story, a Set Department within the Art Department 114 who design and build the physical setting of the story, a Props Department 116 who is responsible for any object movable or portable on a stage or set, distinct from the actors, scenery, costumes and electrical equipment, Hair and Makeup Departments 118 who are responsible for the makeup, hair and special effects of the characters look on screen, a Sound Department 120 who is responsible for capturing the audio throughout the filming process, Camera and Electrical Departments 122 who are responsible for lighting and capturing the visual portion of the production, a Script Department 124 responsible for communicating script revisions and ensuring overall continuity across the production, and Production Leadership, comprised of the Director, Producers, and Assistant Directors 126.

One of skill in the art can appreciate that when the techniques described herein refer to a particular department or user of the system 100, the referenced department (e.g., class of users) or user is interacting with the system 100 using a computerized device, such as a smartphone, desktop, laptop, and/or the like. For example, the Costume Department 112 refers to a class of users that are responsible for costumes. Each user in this class of users interacts with the system 100 using a computerized device connected to the system 100 via the Internet and/or some other connection (e.g., whether it is the same device, or a different device for each user).

Budgeting and Inventory software stores product data by outfit, by character, by scene. Product data includes: label, brand, product name, model id, SKU #, color, size, price, source, date entered.

An Automatic Script Breakdown process 104 begins with the script being uploaded to a Web application 102. This can be done by a Script Supervisor 124 or any of the individual departments using the software.

Automatic Script Breakdown 104 can be configured to take different electronic representations of the script, such as, for example, a PDF version of the script, or a script file (.FDX) from Final Draft 8 (Final Draft, Inc.). Automatic Script Breakdown 104 analyzes the inputted script file and using a combination of regular expressions, machine learning and fuzzy logic “breaks down” the script. Breaking down the script entails determining the characters in the production, the scenes in the production as well as descriptions of the scenes, which characters are in each scene, as well as the script timing to help with the planning of the production designers.

A Web application database 110 contains the results of a script parser 104 and is accessible through web application 102, mobile applications 106, and desktop application 108. It then allows each of the departments to plan their inventory throughout the application, syncing with all devices enabling collaboration between team members. Each individual production department can manage their own breakdown, or the Script Supervisor 124 or Production Leadership 126 can manage a single universal script ensuring each department has up to date accurate information.

Both mobile application 106 and desktop application 108 allow for offline usage and asynchronous syncing with database 110. Conflict resolution is handled by the time the change is made and the rank of the user making the change.

Costume Departments 102, Set Departments 114, Props Departments 116, and Hair and Makeup departments 118 use Script Parser 104 to break down the script, telling them when costumes, sets, props and actor looks need to be planned. Each department works with production leadership to create the look and feel desired for the film. For example, costumes, planned by Costume Departments 102, consist of the clothing and apparel worn by actors; sets, planned by Set Departments 114, consist of the design and creation of structures and interior spaces; props, planned by Props Departments 116, consist of the items handled by an actor, consumable food and any other items surrounding the actors that is not part of the scenery or costumes; actor hairstyles, are planned and created by the Hair departments and actor facial and body appearances are planned and created by the Makeup departments of the Hair and Makeup departments 118.

From here each department uses the software to budget the items they need per scene as well as the character or location these items are for. Finally, during shooting the mobile applications 106 are used as the digital record book of everything used as well as when it is used.

Sound Departments 120 and Camera and Electrical Departments 122 use the software to plan what equipment is needed for each scene as well as the placement of that equipment. For example, Sound Departments 120 operate the computers recording sound, such as mixing the audio while filming as well as placing and operating microphones. As another example, Camera and Electrical Departments 122 work together to plan the lighting and framing of shots under the order of the Director of Photography, they're responsible for both the placement and operation of cameras and lighting equipment. In some embodiments, both departments use the software to track the type of equipment used, its settings, the positioning of the equipment, and/or the like. In post-production the data integrates with the editing process, helping editors to choose which cameras and microphones to use.

Director, Producers and Assistant Directors 126 use the software as a viewpoint into the creative process, allowing them to ensure the creative designers they employ are creating designs that match their intended look and feel for the production. For example, a director can automatically view the sets planned for a particular scene by Set Department 114, the costumes planned for a particular scene by Costume Department 102, and/or other items to make sure they approve of the planned items.

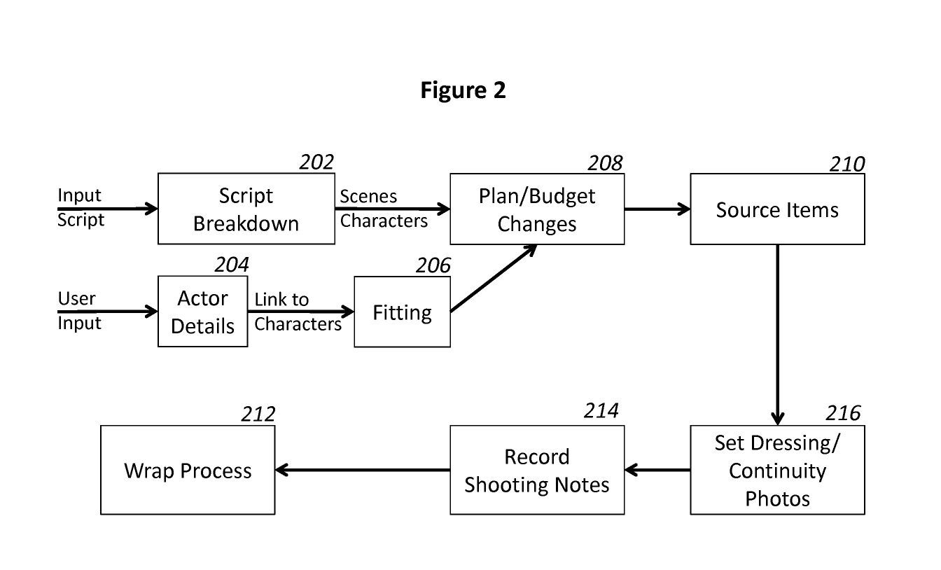

FIGS. 2 & 3 illustrate the workflow of the Costume Department while using the production management system 100.

Unless the Script Supervisor 124 is managing the script for the entire production, a Costume Supervisor 302 performs a script breakdown 202 for the costume department. The Costume Supervisor and the Costume Designers 304 enter necessary information about the actors including sizing, and contact information in the Actor Details block 204.

Next the Costume Designers and Costume Supervisor collaborate to budget and plan changes 308 using web application 102. The Assistant Costume Designers, Key Costumers and Set Costumer perform fittings and can recording pictures and exact sizing in block 306 using the mobile application 106.

Based on the planned outfits provided, a buyer or coordinator 310 uses the mobile application to source the products. Assistant Costume Designers, Key Costumers and Set Costumers 306 ensure that the items were correctly purchased and fit as desired.

After this the Key Costumer, Set Costumer and Truck Supervisor use the web application to organize inventory, dress the characters, and the mobile application to take continuity photos throughout the shooting process 314.

Finally, the Costume Supervisor 312 can enter wrap storage information for the outfits used, and generate a wrap report based on all of the information and photos taken by the rest of the department 212. For example, the wrap report is an index of all of the clothing and inventory used throughout filming as well as what was done with each product after filming is completed. In some embodiments, this report indicates whether an item was returned to a rental house or store, given away to a cast or crewmember or stored in boxes, called wrap boxes, in the studios archival warehouse.

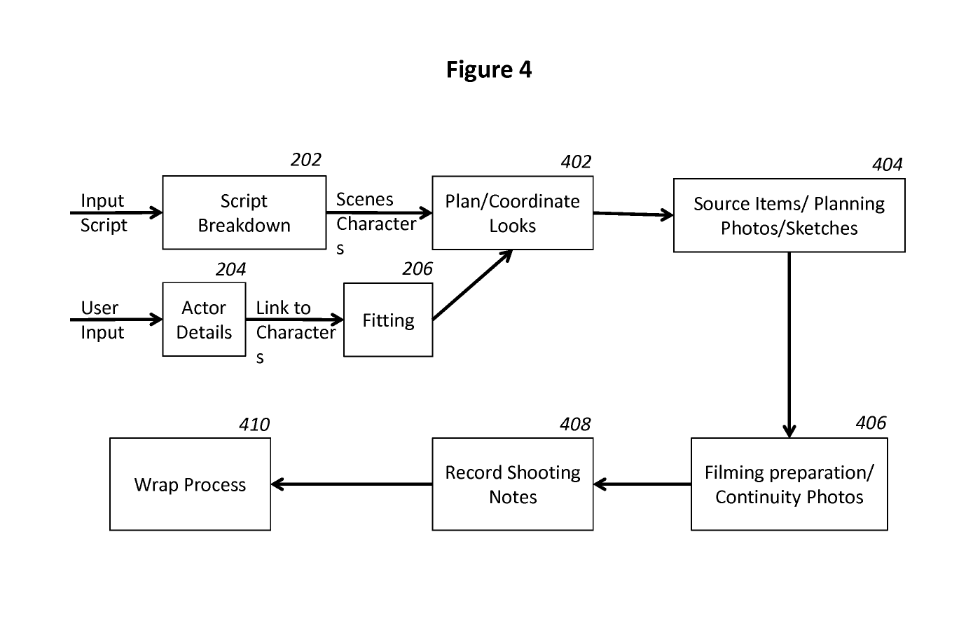

FIG. 4 illustrates the workflow of the Hair and Make-up Departments while using the production management system 100.

Unless the Script Supervisor 124 is managing the script for the entire production, the department heads from either the Hair or Make-up departments perform the script breakdown 202 for their respective departments. In some embodiments, the script breakdown provides the Hair and Make-up departments with the scenes, characters, which characters are in each scene, and scene details such as the scenes location, a short description of what occurs in the scene, whether it takes place indoors or outdoors, the timing of the scene, and/or the like. They also enter relevant details about the actors, for example, hair color, eye color, skin tone, hat size, wig measurements and allergies at Actor Details block 204, which is linked to the characters for fitting. As necessary, the stylist will perform fittings for accessories such as hats and wigs using the mobile application as indicated at the Fitting block 206. For example, stylists can record actors fitting information in a text form, as well as taking pictures of the actual actor, potential items to be used and any sketches created in the planning process.

After determining when different looks are needed 402, the Hair and Make-up stylists use the mobile application to record pictures of their planning/practice photos and sketches. They also use the mobile application to reference needed items and fitting information while sourcing items 404.

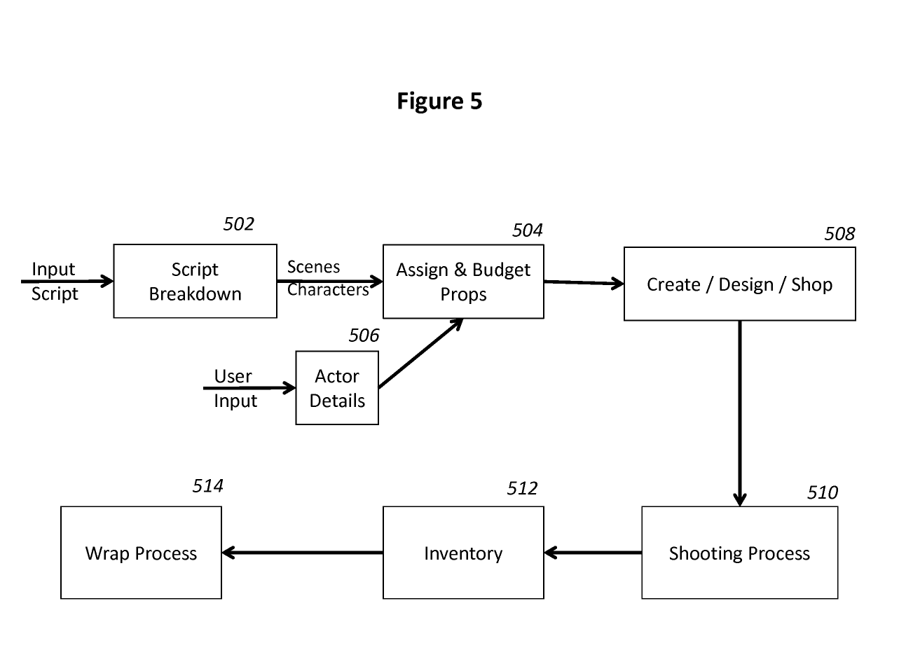

FIG. 5 illustrates the workflow of the Props Department while using the production management system, according to embodiments of the present disclosure.

Props Departments 116 is a part of the Art Department, but oftentimes handles their own script breakdown. Unless Script Supervisor 124 is managing the script for the entire production, the head of a Props Department 116, a Propmaster executes the automatic script breakdown 104 for Props Departments 116. Props Departments 116 can use, for example, all of the information provided by the script breakdown including the scenes, characters, which characters are in each scene, and scene details to plan which props are needed when. The Propmaster and their assistants, enter relevant actor details as well as referencing information from other departments entered for actor details 506.

Props Department 116 then uses the web application to plan, assign and budget props throughout the script breakdown as shown in block 504. They then reference these plans while they are creating, building and shopping for props using a combination of web application 102 and mobile application 508. In some embodiments, a Propsmaster will use the web application throughout the planning and budgeting phase, with their assistants using the mobile application to ensure their props match the plans while they are on the go building and shopping.

Throughout the shooting process the Props Department uses the mobile application to manage their inventory and record continuity photos and notes as shown at blocks 510, 512. The wrap process is particularly important for custom-built props, either in allowing the team to find them after shooting (e.g., by specifying a storage location), or providing the team with accurate plans to rebuild the prop in the event of a reshoot 514.

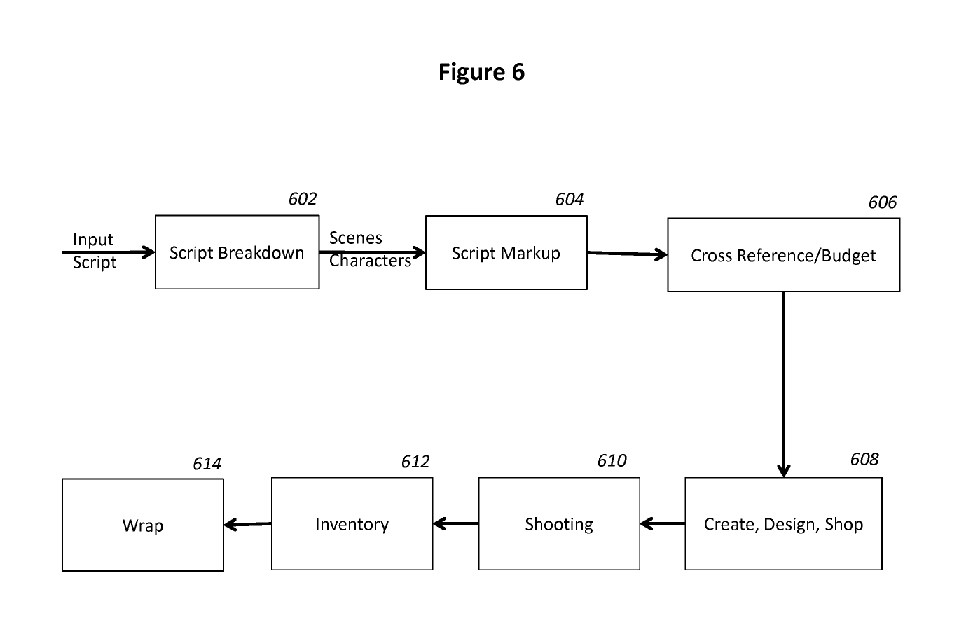

FIG. 6 illustrates the workflow of the Art Department (specifically Set Decorators) while using the production management system, according to embodiments of the present disclosure.

The Set Decorators are also a part of the art department, but unless Script Supervisor 124 is managing the script for the entire production the Set Decorator performs their own script breakdown 602. During this script breakdown they identify sets/locations and plan the objects to be acquired for each set.

Next, the Set Decorators use the web application to mark up the script with notes, listing requirements for action props, animals, vehicles, dressing props and any graphic items needed to shoot each scene 604.

When the Set Decorators know the needed items, they can put together a budget and cross reference the list of needed items with the Production Buyers and Graphic Artists or the production at block 606. Throughout this period the Set Designers can use the web application to work on product placement arrangements or on acquiring copyright clearances for any branded items in the budget. For example, when items are listed by brands or their agents in the product placement listings, they are done so with absolute or conditional approval clearance (e.g., where absolute approval is the right to use the product unconditionally in a specified production, and conditional approval meaning the product must be used in a specific way or can only be worn or used by specific characters). Designers search through listed items, and can choose to use an item. In some embodiments, the designer agrees to standardized terms to receive brand clearance.

When the budget is complete, the Set Decorators can locate, purchase, hire and/or make the required items, recording progress using the mobile application 106 at step 608.

Before shooting begins, the Set Decorators and their teams arrive to begin dressing the set according to their plans 610. After the Set Designer has checked over the set and made any last minute changes or additions, both the Director and the Director of Photography give their approval, either in person or through the Production Dashboard 1100.

Throughout the shooting process, the Set Department use the mobile application to record an inventory list and photo album of every action prop, animal, vehicle, dressing props and graphic item used 612.

Finally the Set Decorator oversees the return of all hired props to their sources in the appropriate condition and organizes the sale, safe disposal or storage of any other props during the wrap process 614. Throughout this process they record their progress using the web application.

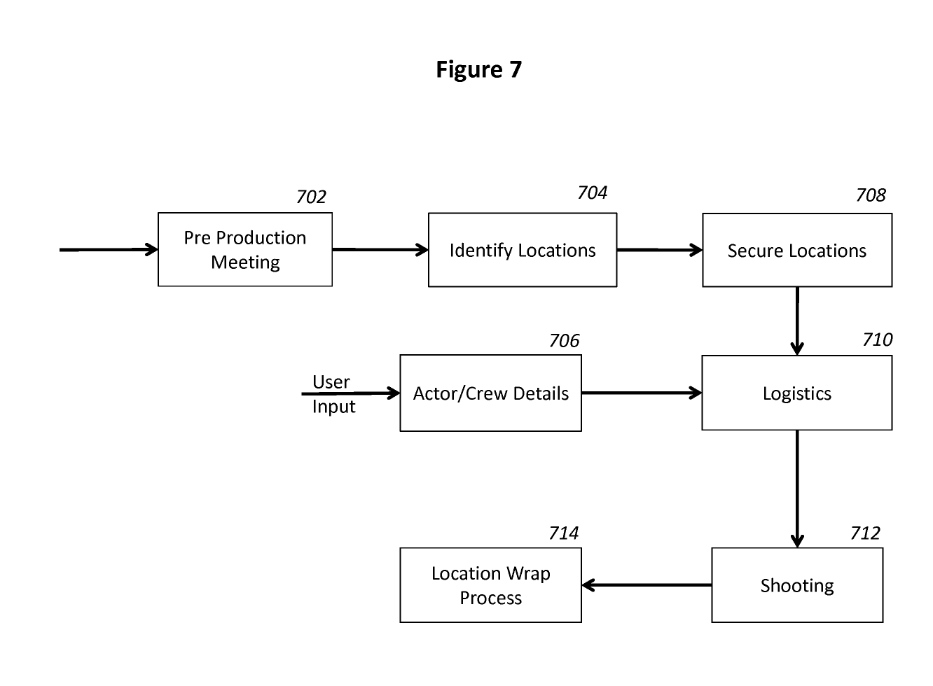

FIG. 7 illustrates the workflow of the Locations Department while using the production management system, according to embodiments of the present disclosure.

The Locations Department begins with a pre-production meeting with the creative leadership to understand the creative vision of production 702.

The Locations Department next identifies what locations are necessary, and works to identify appropriate locations using web application 102. The Locations Department can build a photograph-based storyboard for the production using mobile application 106 to upload photos at block 704. Using the production dashboard 1100 the Locations Department can share these photos with production leadership to receive approval, and with other departments to aid in their production planning processes. When they have identified the necessary locations, they begin to work on securing locations 708. This process is recorded in mobile application 106, and consists of negotiating contracts, shooting dates, paperwork permits and other logistics to ensure a smooth shoot process.

While securing locations, the department starts by securing details on the cast and crew at block 706, providing options for room and board for remote shooting locations. Furthermore they help to organize the logistics of transporting and storing all of the people and items used at each remote shooting location 710. They need to ensure cast and crew know where to be when, secure production power sources, catering, legal permissions and prevent any possible crowd disruption. In some embodiments, the department sets this on the web application, with the team referencing this from the mobile application while in the field.

Throughout the shoot, the Locations Department uses a combination of the web and mobile applications to handle Fire, Police and all other authorities, and keep track of making sure the cast and crew can get to set on time as well as placating any issues that arise with external parties 712.

When the Locations Department secures a location; they begin by taking photos of the location using the mobile application. Upon wrapping at the location they need to reference these photos to make sure they leave the location as they found it and to avoid any potential disputes or contract breaches with location owners/authorities 714.

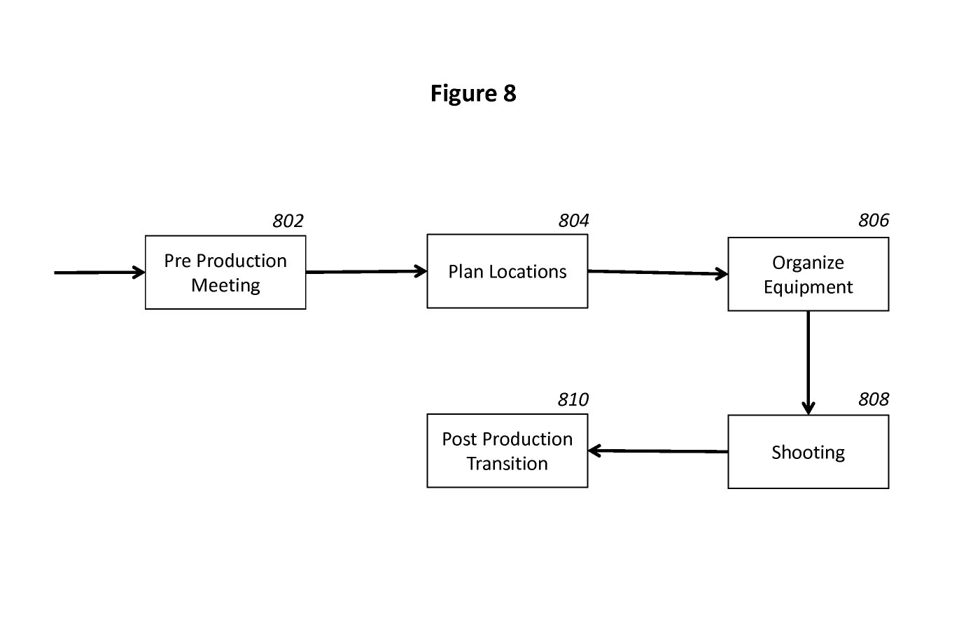

FIG. 8 illustrates the workflow of the Camera and Electric (Lighting) Departments while using the production management system, according to embodiments of the present disclosure.

The Camera and Electric departments attend a preproduction meeting where they receive shooting locations and schedules, as indicated in blocks 802, 804. The department heads plan logistics and plan what is needed for equipment at block 806. Throughout shooting, they make sure that all equipment is in working order and in place on schedule. Using the Production Management System 100 they record positioning via set diagrams and blueprints of lighting/camera equipment to be saved in the event of reshoots and passed on to the prost production editors at block 808. This information helps the editors choose which cameras and microphones to use without having to watch each take from each camera at block 810.

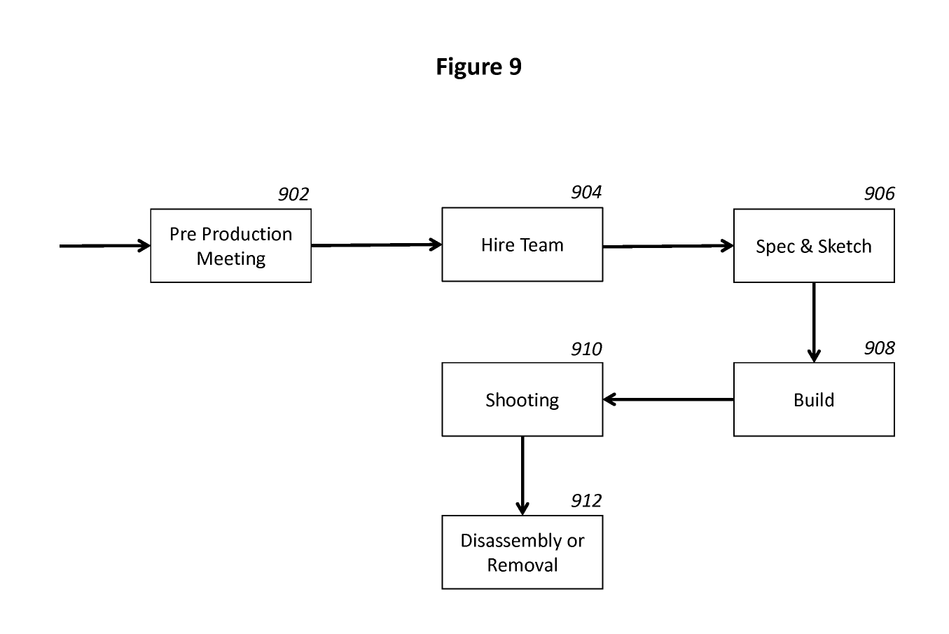

FIG. 9 illustrates the workflow of the Construction Department while using the production management system, according to embodiments of the present disclosure.

The Construction Department starts with the construction manager meeting with the production designer and art director to get an idea of what the deliverables are for the production at block 902.

Depending on the type of the production they will either need to construct a set from scratch, or make modifications to an existing set or location. These factors will determine the necessary team size. As new team members join, orientation and training materials consisting of manuals, interactive help tips and videos can be shared using the web application 106 at block 904.

The Construction Manager is then sent the drawings from the Art Department 114; the Construction manager turns these drawings into blueprints useable by the rest of the Construction Department at block 906 and can photograph or upload these blueprints into the system.

Using the mobile application as a reference and to send pictures to receive approval, the construction department then builds everything (e.g., the sets, etc.) according to the shooting schedule and budget at block 908.

Throughout the shooting process the construction team references the original pictures for any changes that need to be made on the fly, any breakages, fixed, repairs or rebuilds at block 910. The Construction manager also uses the application to interact with the visual effects teams to ensure shoots are done properly to speed up the prost production process.

After shooting the Construction Department handles wrap by disassembling, removing, moving or preparing for storage any sets they've made. Before disassembly they take a final set of pictures using the mobile application 106 in the event they need to recreate a particular set.

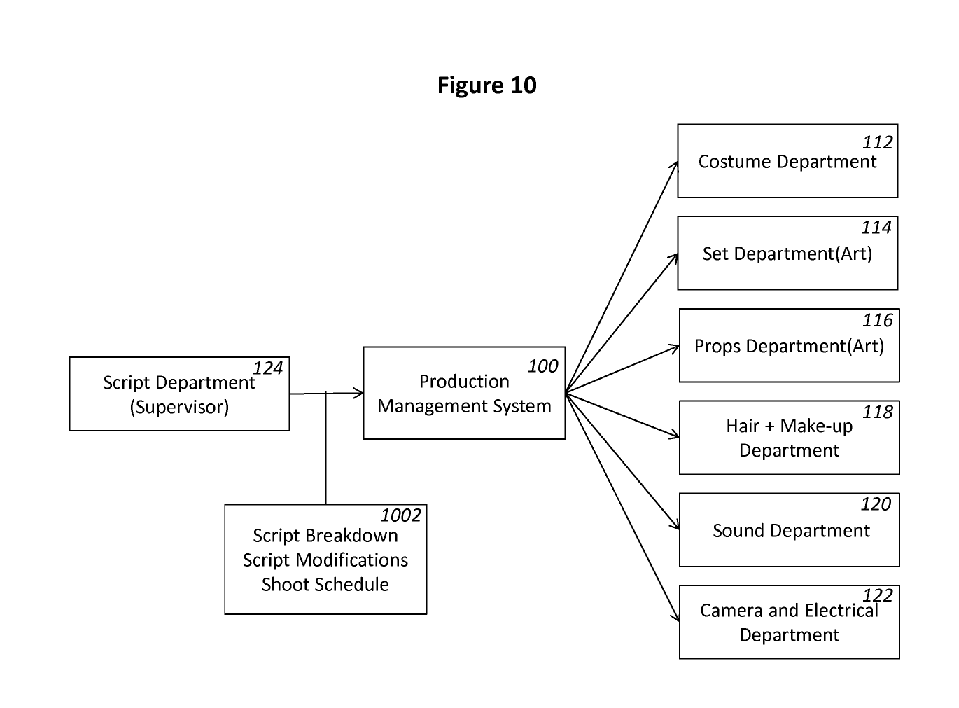

FIG. 10 illustrates the workflow of the Production Office (specifically Script Supervisor and Assistant Directors) 124 while using the production management system to plan a production, according to embodiments of the present disclosure.

Traditionally each department usually manages their own script breakdown, often with a manual process. This breakdown includes any revisions to the script that occur while shooting the film at step 1002. Script Supervisor 124 can make the changes once for all of the departments through a production using the web application, and serve as the source of truth for script information on set. For example, even if various departments use their own independent script breakdown, script modifications that occur at step 1002 can be automatically propagated to the various departments (e.g., Costume Departments 112, Set Departments 114, and so on) if allowed by the individual department.

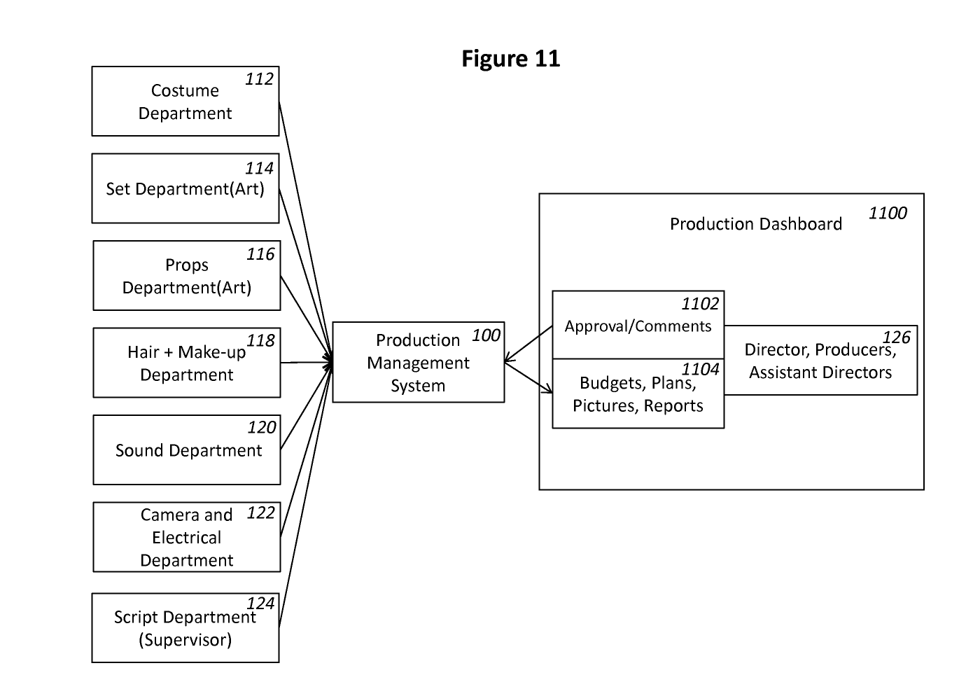

FIG. 11 illustrates the workflow Production Leadership (Producers and Directors) can use to supervise their production, including approving/providing feedback on creative plans and budgets, auditing expenses and reviewing reports using a Product Dashboard 1100.

Anyone on a production can send a message to any other person on his or her production, in addition they can send a message to Production Leadership 126 who do not otherwise use application 100. In some embodiments, messages are sent from the production dashboard 1100, if a user is not registered, messages are addressed via their email address and the recipient is given a unique link allowing them to complete a simplified registration process to view their messages. Messages can contain budgets, plans, photos and department specific reports, as well as free-form text as shown in block 1104.

Recipients of a message can attach comments to the thread the message creates, or simply vote to approve or deny the contents of the message 1102 using either the web or mobile application.

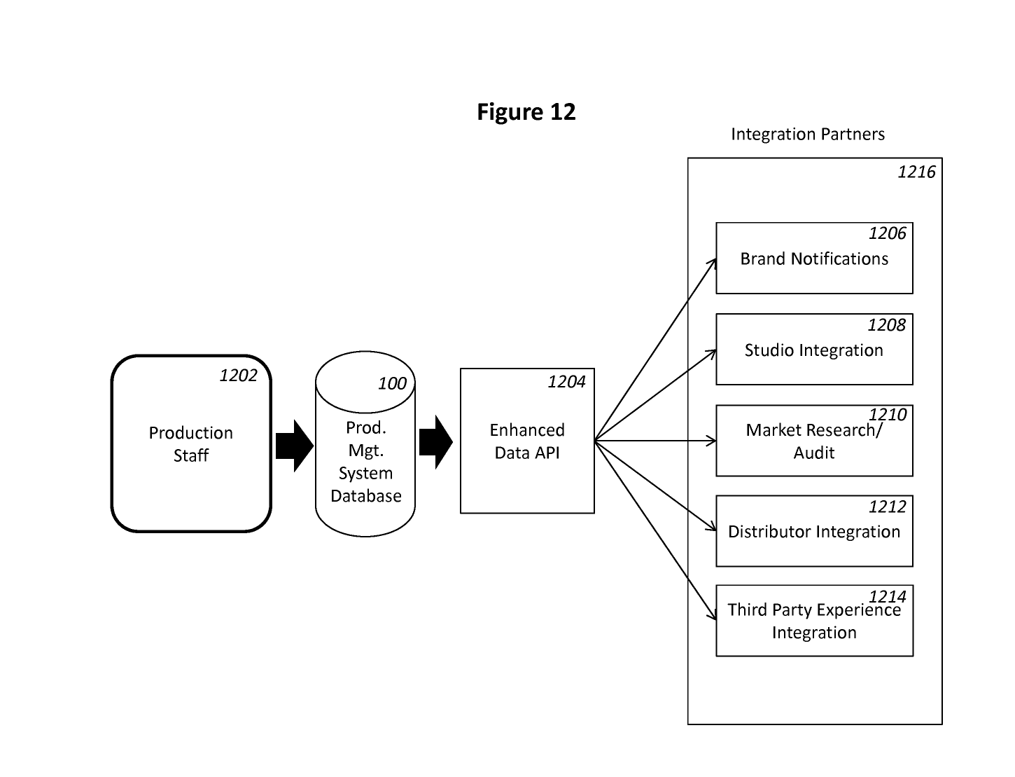

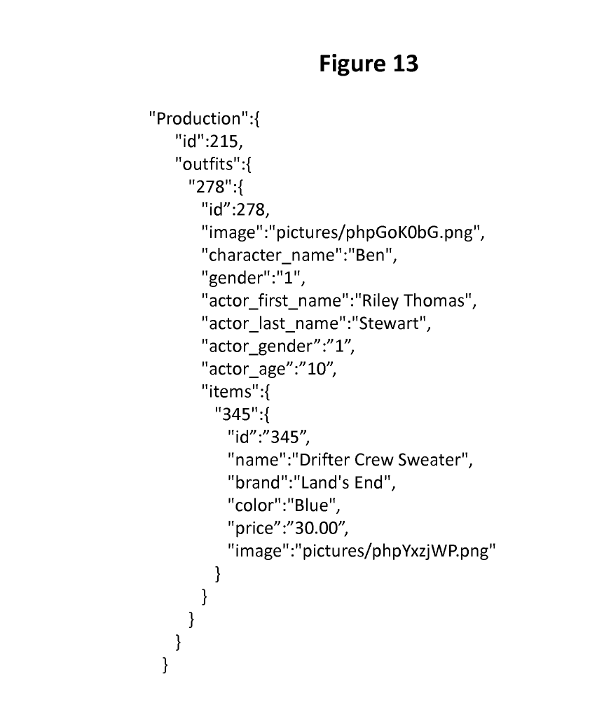

FIG. 12 details the path of data inputted in a production to external integrators through an Enhanced Data API 1204. This data path begins with Production Staff 1202 entering information into the Production Management System's Database 100. For example, this data undergoes enhancement in the form of adding e-commerce links, pictures, as well as brand website links where available in our seed database. After enhancement, this data is available to Integration Partners 1216 through the Enhanced Data API 1204. Integration Partners 1216 include Brands 1206 involved in productions using the Production Management System, Studios 1208 supporting the production management system, Brands and Advertising agents 1210 (Ad Agencies etc.), Content Distributors 1212 (e.g. Networks, Cable Networks, Online providers), and Third Party Experience providers 1214 (e.g. second screen applications, interactive web experiences, social media applications). An example of a data request to the Enhanced Data API 1204 can be seen in FIG. 13.

Brand Notifications 1206 consist of notifying Brands when their products appear in productions using the Production Management System. Brands can utilize this data for real time advertising, cross promotion with productions, and tracking the efficacy of product placement.

Studio Integrations 1208 provide the studio with information on all of the products used in their productions. This can be used, for example, to leverage wider product placement/advertising as well as for tax and audit/asset reporting purposes.

Market Research/Audit 1210 is used to create reports analyzing the prevalence of different products and brands in active productions. It is utilized by parties such as advertising agencies and members of the press to analyze trends in near real-time.

Distributor Integration 1212 allows parties such as television networks (e.g. Fox, CBS, NBC, ABC), cable networks (USA, TNT etc.) and online video players (e.g. Amazon, Netflix, Hulu etc.) to supplement their content with all of the information used to create the production, as well as to provide e-commerce opportunities.

Third Party Experience Integration 1214 allows external parties to supplement television and film content. An example of an integration would be targeted advertising to users of a social networking discussing a particular production.

FIG. 13 shows a sample data return for the API call of what is on screen now. The API returns JavaScript Object Notation (“JSON”) formatted data with links to images from the production. This example call is for an outfit entered by the Costume Department. The “id” fields are unique identifiers for the production, outfit and items. The image fields are relative links, providing the actual image file matching the respective object. The gender fields are a Boolean flag, with “1” indicating male, and “0” indicating female.

The API calls can take in various arguments. For example, the API calls, on screen now, next “X” items, an/or next “X” minutes can be configured to take in the arguments of the show id, as well as the time within the show. The API call on screen now can be configured to list the characters as well as the outfits they are wearing and the items that make up those outfits. The API call next “X” items can do this for the next “X” number of items that will appear in the show, with next “X” minutes doing the same but listing the items appearing in the next “X” number of minutes. The full show API call can be configured to provide all of the items in a particular production.

In some embodiments, the API allows searching by show, brand or product in order to provide up to the minute analytics around placement.

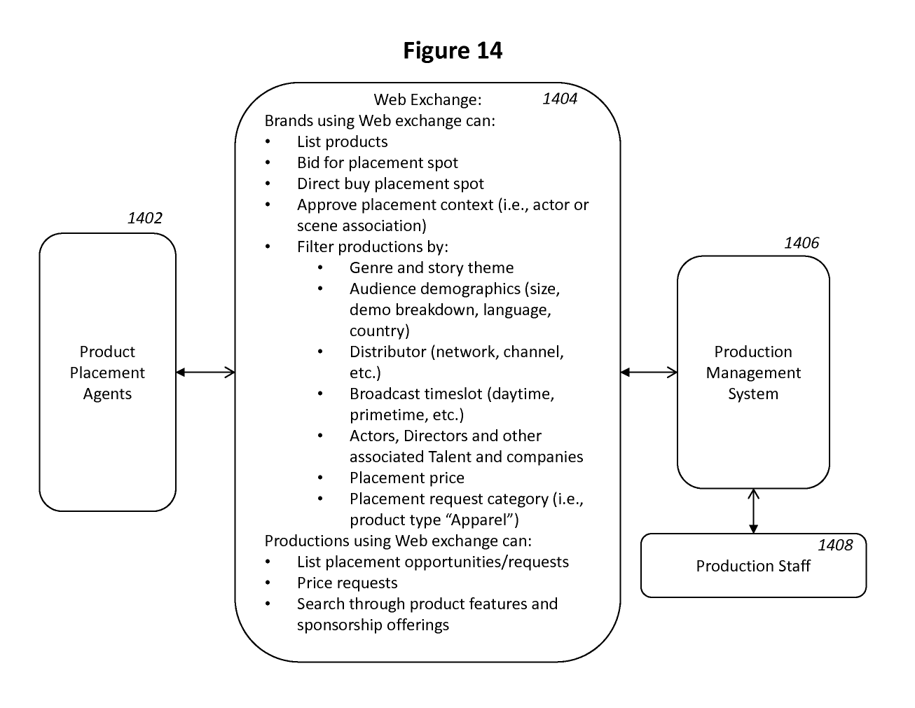

FIG. 14 illustrates the product placement exchange at a high level. A Product Placing Agent 1402 represents the party trying to place a product into the content. Here the product placing agents list the products they would like to place (e.g., into a media production). A private web portal 1404 exchange can be accessed to filter potential productions and bid for placements. This web portal ties into the production software 1406 used by the production designers 1408 to manage their inventory. The web exchange 1404 recommends placement opportunities and uses based on budget.

A Production staff 1408 tracks inventory using the production software 1406. The production software 1406 stores the product data relevant to their department by outfit, character and scene. An example of the relevant product data is the clothing and apparel information for the Costume Department. After a script is uploaded, the software helps the production designers when they need to create designs. The first step in them creating the design is to plan and budget the items involved in the outfit or set. The software is able to provide matches based on the items budgeted for a production. For example, if a production budgets a red shirt, the brands with red shirts listed are recommended to the production designer.

Product Placement Agents 1402, including brands and advertising agencies, are able to list products or open their catalog to the productions they have indicated interest in. Product Placement Agents can choose which productions they have interest in either by specifically selecting productions from the list of productions using the software who have indicated they are looking for product placement or by providing criteria for appropriate productions. An example of these criteria is television shows with greater than 1 million viewers rated TV-14 or less. Individual products can have further criteria such as, must be worn by male 18-35 with a speaking role

The Product Placement Agents 1402 can filter productions based on, for example, genre and story theme, audience demographics, distributor, broadcast timeslot, talent associated with the production, price and/or product category to identify productions of interest.

Product Placement Agents 1402 can bid set values to improve items listing positions within the exchange encouraging selection by production staff. They may also buy placements listed by production staff.

When the production designers 1408 plan and budget the looks they will be creating, potential placement opportunities are recommended by the web exchange 1404. Potential placement opportunities can be recommended by comparing needed items with items brands have listed in the product placement listings. Needed items can be determined by the productions budget (e.g. if the production budgets a red shirt, brands interested in placing products in the production that make redshirts are recommended). These recommendations are made to the designer before they shop for the items to create the style. The web exchange connects directly to the production software's database, so that recommendations may be made for matches.

Production designers 1408 using the web exchange can list placement opportunities and requests for products, list prices for placements and search through products listed by product placement agents and can continually track and budget.

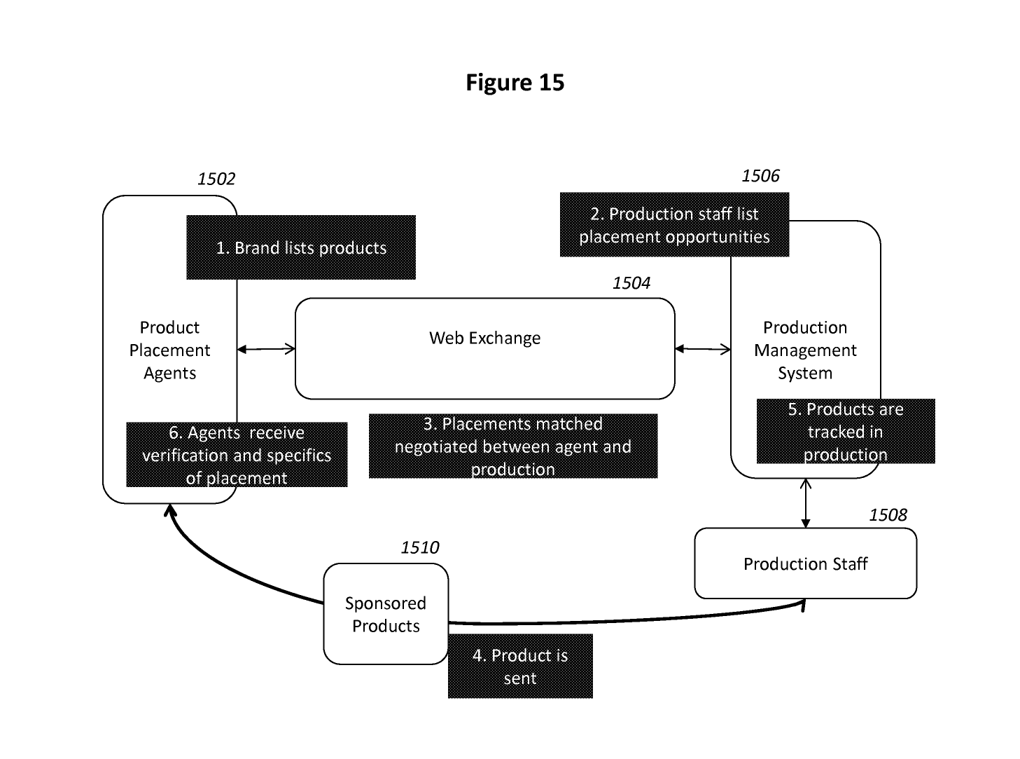

FIG. 15 provides an example of the flow from a Product Placement agent to the production, as well as the flow of data and analytics around the placement back to the Product Placement agent.

A Product Placement Agent 1502 lists the products (e.g., clothing, consumables, etc.) into the web exchange 1504, and Production staff 1508 list placement opportunities (e.g., scenes, characters, props, etc.) through the production software 1504. The web exchange recommends and matches placements between an agent and the production (e.g., based on price, budgeted item specifications).

Accepted matches 1510 are sent to the production set where the production staff 1508 receive and use the items. The placement fee is held in escrow until the item is included in the production and tracked using the software. This information is passed back to the Product Placement Agent along with viewer analytics, time on screen etc.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A computerized method for electronically organizing physical production of a media production, comprising:
receiving, by a computing device, an electronic script for a media production, the script comprising a plurality of scenes, each scene comprising at least one or more characters for the scene and one or more sets for the scene;
processing, by the computing device, the electronic script to automatically generate a script data object that comprises data indicative of the plurality of scenes, and for each scene:
data indicative of the at least one or more characters for the scene;
data indicative of the one or more sets for the scene; and
data indicative of at least one or more items for a character from the one or more characters, a set from the one or more sets, or both; and
electronically distributing, by the computing device, the script data object to one or more departments involved in producing the media production to electronically organize the physical production of the media production among the one or more departments.

2. The computerized method of claim 1, further comprising:
receiving product information for an item from the one or more items from a first department of the one or more departments; and
storing the product information in a database in communication with the computing device such that the product information is associated with the first scene based on audio content of the first scene.

3. The computerized method of claim 2, further comprising:
receiving a request from a consumer to identify the item in the first scene;
identifying the product information based on the audio content of the first scene; and
transmitting the product information to the consumer.

4. The computerized method of claim 2, further comprising:
identifying a second scene from the plurality of scenes in which the item appears; and
storing the product information in the database such that the product information is associated with the first scene based on audio content of the first scene and the second scene based on audio content of the second scene.

5. The computerized method of claim 1, further comprising:
receiving an updated electronic script for the media production;
processing the updated electronic script to automatically generate an updated script data object; and
electronically distributing the updated script data object to the one or more departments.

6. The computerized method of claim 1 further comprising:
receiving an electronic list of products for placement in the media production;
receiving an electronic list of placement opportunities in the media production; and
determining a match between a product in the electronic list of products and a placement opportunity in the electronic list of placement opportunities.

7. The computerized method of claim 6 further comprising:
storing data indicative of usage of the product in the placement opportunity; and
generating analytics data based on the usage of the product.

8. A computerized system for electronically organizing physical production of a media production, comprising a processor configured to run a module stored in memory that is configured to cause the processor to:
receive an electronic script for a media production, the script comprising a plurality of scenes, each scene comprising at least one or more characters for the scene and one or more sets for the scene;
process the electronic script to automatically generate a script data object that comprises data indicative of the plurality of scenes, and for each scene:
data indicative of the at least one or more characters for the scene;
data indicative of the one or more sets for the scene; and
data indicative of at least one or more items for a character from the one or more characters, a set from the one or more sets, or both; and
electronically distribute the script data object to one or more departments involved in producing the media production to electronically organize the physical production of the media production among the one or more departments.

9. The system of claim 8, wherein the module is further configured to cause the processor to:
receive product information for an item from the one or more items from a first department of the one or more departments; and
store the product information in a database in communication with the computing device such that the product information is associated with the first scene based on audio content of the first scene.

10. The system of claim 9, wherein the module is further configured to cause the processor to:
receive a request from a consumer to identify the item in the first scene;
identify the product information based on the audio content of the first scene; and
transmit the product information to the consumer.

11. The system of claim 9, wherein the module is further configured to cause the processor to:
identify a second scene from the plurality of scenes in which the item appears; and
store the product information in the database such that the product information is associated with the first scene based on audio content of the first scene and the second scene based on audio content of the second scene.

12. The system of claim 8, wherein the module is further configured to cause the processor to:
receive an updated electronic script for the media production;
process the updated electronic script to automatically generate an updated script data object; and
electronically distribute the updated script data object to the one or more departments.

13. The system of claim 8, wherein the module is further configured to cause the processor to:
receive an electronic list of products for placement in the media production;
receive an electronic list of placement opportunities in the media production; and
determine a match between a product in the electronic list of products and a placement opportunity in the electronic list of placement opportunities.

14. The system of claim 13, wherein the module is further configured to cause the processor to:
store data indicative of usage of the product in the placement opportunity; and
generate analytics data based on the usage of the product.

15. A non-transitory computer readable medium having executable instructions operable to cause an apparatus to:
receive an electronic script for a media production, the script comprising a plurality of scenes, each scene comprising at least one or more characters for the scene and one or more sets for the scene;
process the electronic script to automatically generate a script data object that comprises data indicative of the plurality of scenes, and for each scene:
data indicative of the at least one or more characters for the scene;
data indicative of the one or more sets for the scene; and
data indicative of at least one or more items for a character from the one or more characters, a set from the one or more sets, or both; and
electronically distribute the script data object to one or more departments involved in producing the media production to electronically organize the physical production of the media production among the one or more departments.

16. The non-transitory computer readable medium of claim 15, wherein the executable instructions are further operable to cause an apparatus to:
receive product information for an item from the one or more items from a first department of the one or more departments; and
store the product information in a database in communication with the computing device such that the product information is associated with the first scene based on audio content of the first scene.

17. The non-transitory computer readable medium of claim 16, wherein the executable instructions are further operable to cause an apparatus to:
receive a request from a consumer to identify the item in the first scene;
identify the product information based on the audio content of the first scene; and
transmit the product information to the consumer.

18. The non-transitory computer readable medium of claim 16, wherein the executable instructions are further operable to cause an apparatus to:
identify a second scene from the plurality of scenes in which the item appears; and
store the product information in the database such that the product information is associated with the first scene based on audio content of the first scene and the second scene based on audio content of the second scene.

19. The non-transitory computer readable medium of claim 15, wherein the executable instructions are further operable to cause an apparatus to:
receive an updated electronic script for the media production;
process the updated electronic script to automatically generate an updated script data object; and
electronically distribute the updated script data object to the one or more departments.

20. The system of claim 15, wherein the module is further configured to cause the processor to:
receive an electronic list of products for placement in the media production;
receive an electronic list of placement opportunities in the media production; and
determine a match between a product in the electronic list of products and a placement opportunity in the electronic list of placement opportunities.
